(19) United States
(12) Patent Application Publication
(10) Pub. No.: US 2006/0017577 A1
(43) Pub. Date: Jan. 26, 2006

(54) Systems and methods for the detection of termites

(76) Inventor: Kyle Broussard, Beaumont, TX (US)

Correspondence Address: BAKER BOTTS, LLP, 910 LOUISIANA, HOUSTON, TX, 77002-4995, US

(21) Appl. No.: 11/021,574

(22) Filed: Dec. 22, 2004

Related U.S. Application Data
(60) Provisional application No. 60/590,502, filed on Jul. 23, 2004.

(51) Int. Cl. G08B 23/00; G08B 21/00; A01M 1/20

(52) U.S. Cl. 340/573.2; 340/602; 43/132.1

(57) ABSTRACT

The present invention provides termite detection systems, the systems comprising at least one sensor, wherein the sensor generates a signal when there is moisture caused by termite activity; at least one digital processor coupled to the sensor, wherein the digital processor receives the signal from the sensor; and at least one warning device coupled to the digital processor, wherein the warning device is activated when the digital processor receives the signal form the sensor. The present invention also provides methods for detecting termites in a building, the methods comprising: installing a termite detection system in the building; and monitoring the termite detection system until moisture is detected in the building.

### CROSS-REFERENCE TO RELATED APPLICATION

This Application claims priority to commonly owned U.S. Provisional Patent Application Ser. No. 60/590502; filed Jul. 23, 2004; entitled “The Termite Alarm,” by Kyle Broussard; which is incorporated herein by reference.

### BACKGROUND

The present invention pertains to systems and methods useful for detecting termites. Certain embodiments of the systems and methods disclosed may be particularly suitable for detecting moisture in a building. Certain embodiments of the systems and methods disclosed may be particularly suitable for detecting the presence of termites in a building.

Many buildings are susceptible to damage from moisture. This damage may take the form of cosmetic or structural damage to the building. For example, in some buildings moisture may damage wood or drywall or both. Mold also may colonize a building when excessive moisture is present, which may lead to health problems for the occupants of the building.

And moisture in a building may indicate a number of other problems. For example, the presence of moisture in a building may indicate the presence of a plumbing leak or structural leak (e.g., a roof leak). Moisture also may be brought into a building as a result of termite activity and therefore indicate the presence of termites. Termites often transport moisture into a building when feeding on the building's wood.

But moisture, mold, and termites are often difficult to detect because they may occur inside wall cavities, which are, for the most part, impossible to observe absent an intrusion into or removal of a portion of the walls. Accordingly, early identification of moisture in a building may allow for a quick response to remedy any potential problem arising from or indicated by the presence of moisture. And in the case of termites, early identification of where termites have initially invaded the building may serve to prevent a major infestation and the costs associated with repairing any damage to the building after they are exterminated.

### SUMMARY

The present invention pertains to systems and methods useful for detecting termites. Certain embodiments of the systems and methods disclosed may be particularly suitable for detecting moisture in a building. Certain embodiments of the systems and methods disclosed may be particularly suitable for detecting the presence of termites in a building.

In one embodiment, the present invention provides a termite detection system, the system comprising: at least one sensor, wherein the sensor generates a signal when there is moisture caused by termite activity; at least one digital processor coupled to the sensor, wherein the digital processor receives the signal from the sensor; and at least one warning device coupled to the digital processor, wherein the warning device is activated when the digital processor receives the signal from the sensor.

In another embodiment, the present invention provides method for detecting termites in a building, the method comprising: installing a termite detection system in the building, wherein the termite detection system comprises: at least one sensor, wherein the sensor generates a signal when there is moisture caused by termite activity; at least one digital processor coupled to the sensor, wherein the digital processor receives the signal from the sensor; and at least one warning device coupled to the digital processor, wherein the warning device is activated when the digital processor receives the signal from the sensor; and monitoring the termite detection system until moisture is detected in the building.

The features and advantages of the present invention will be readily apparent to those skilled in the art upon a reading of the description of the embodiments that follow.

### DRAWINGS

The same numerals in different drawings indicate the same parts of a disclosed system.

FIG. 1 shows a cross-sectional schematic of one embodiment of the systems of the present invention placed in a building.

FIG. 2 shows a cross-sectional view of a wafer used in some embodiments of the systems of the present invention.

FIG. 3 shows a side-view of a plurality of sensors multiplexed according to one embodiment of the present invention.

FIG. 4 shows a cross-sectional view of an enclosure housing some of the components of one embodiment of the systems of the present invention.

These drawings form part of the following description and illustrate specific embodiments by which the invention may be practiced. It is to be understood that other embodiments may be utilized and structural changes may be made without departing from the scope of the invention as defined by the appended claims.

### DESCRIPTION

The present invention pertains to systems and methods useful for detecting termites. Certain embodiments of the systems and methods disclosed may be particularly suitable for detecting moisture in a building. Certain embodiments of the systems and methods disclosed may be particularly suitable for detecting the presence of termites in a building.

When placed in the wall cavity of a building, the systems of the present invention may perform a variety of functions. For example, certain embodiments of the systems and methods of the present invention may be useful in detecting moisture. Such systems and methods may be particularly useful, among other things, in termite control efforts, where moisture may indicate the presence of termites. Moisture detection also may be important, for example, in order to alert residents or occupants of buildings about water leaks or mold growth. In general, the systems of the present invention comprise a sensor that is capable of detecting moisture, a digital processor coupled to the sensor, and a warning device coupled to the digital processor.

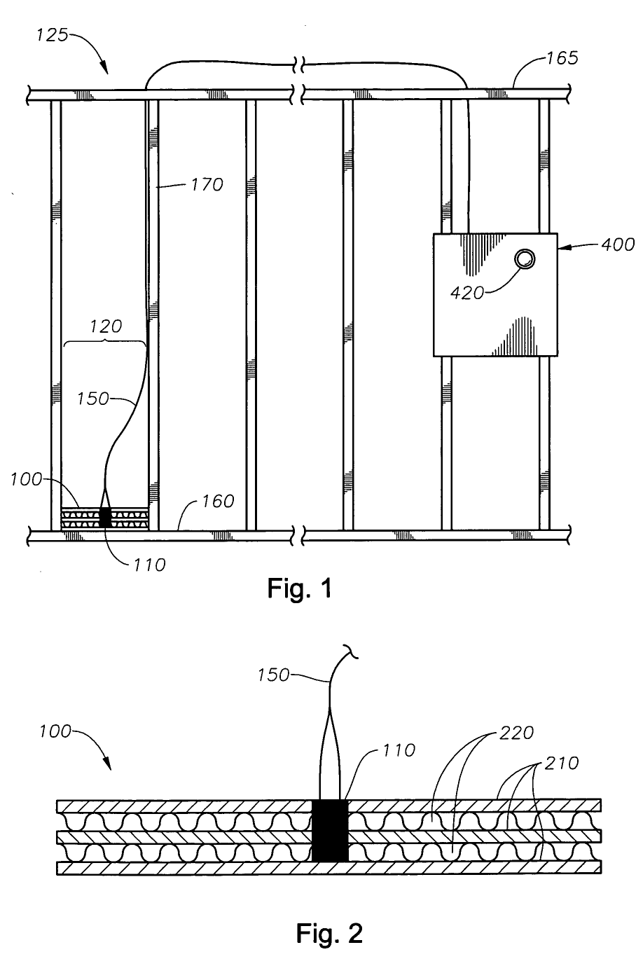

Referring now to FIG. 1, a diagram illustrating a termite detection system according to one embodiment of the present invention is shown placed in wall 125, which may be any wall of any building. Wall 125 includes base plate 160, stud 170, top plate 165, and wall cavity 120. In some buildings, one or more of base plate 160, stud 170, and top plate 165 may be formed from wood.

In one embodiment, the termite detection system of the present invention includes sensor 110, wafer 100, lead 150, enclosure 400, digital processor 410 (not shown in FIG. 1), and warning device 420. Sensor 110 may be at least partially disposed in wafer 100 (also shown in FIG. 2), among other things, to facilitate moisture detection. Sensor 110 is electrically connected through lead 150 to digital processor 410 (shown in FIG. 4), which is housed in enclosure 400. Warning device 420 also is electrically connected to digital processor 410. As used in this description, the term electrically connected refers to any electrical connection capable of completing an electrical circuit, e.g., by using a wire.

In certain embodiments, moisture that may accumulate (e.g., in wall cavity 120 or in wafer 100 ) may trigger sensor 110. Once triggered, an electrical signal passing through lead 150 can be detected by digital processor 410; thereby turning on warning device 420 to alert an operator that moisture was detected.

Warning device 420 may be any warning device capable of alerting an operator. Suitable warning devices include those that produce a visual signal, such as a light; those that produce an audible signal, such as an intermittent beeper (not shown in FIG. 1); or both. In certain embodiments warning device 420 is an amber colored light, such as the model HT8HFAV3 indication light commercially available from Automation Direct, Cumming, Georgia.

Sensor 110 may comprise a sensor capable of detecting the presence of moisture. In certain embodiments, any sensor that operates based on electrical resistance may be suitable for use as sensor 110 in the systems of the present invention. Other sensors suitable for use as sensor 110 include tensiometers, time-domain reflectometers, velocity differentiation domain sensors, capacitance probes, heat dissipation probes, and psychrometers. Example sensors suitable for use in the present invention include the Watermark Soil Moisture Sensor commercially available from Spectrum Technologies, Inc., Planefield, Ill., and the sensor disclosed in U.S. Pat. No. 6,798,220, the relevant disclosure of which is incorporated herein by reference. In one embodiment, sensor 110 is the GB-1 Gypsum Block sensor commercially available from Delmhorst Instruments, Towaco, N.J.

Sensor 110 may be placed in any suitable location within or near a building. In some embodiments, sensor 110 may be placed disposed within or near wall cavity 120. For example, sensor 110 may be disposed substantially within wafer 100, and wafer 100 with sensor 110 may be placed on base plate 160. Sensor 110 also may be placed directly in base plate 160 (not shown in FIG. 1) or stud 170 or both. Such placement may be suitable in portions of a building that cannot accommodate placement of wafer 100.

In general, the location of sensor 110 within a building should be known, especially when placed within a wall cavity like wall cavity 120. Accordingly, a sensor map may be made by labeling a floor plan of the building, or creating a tabular data in a spreadsheet, so as to identify a sensor's location in the building. In certain embodiments, one or more sensors may be placed around the perimeter of the building, among other things, to detect moisture that may result from termite activity. In other embodiments, one or more sensors may be placed adjacent to or near plumbing, among other things, to detect moisture that may accumulate from a plumbing leak or the presence of termites attracted to the leaking water.

Referring now to FIG. 2, a cross-sectional side view illustrates sensor 110 disposed within wafer 100 according to one embodiment the present invention. In general, sensor 110 may be partially or fully disposed in any portion of wafer 100. In certain embodiments, wafer 100 may be of any size or shape suitable for placement in a desired location, for example, between studs that may be present in a building. In certain embodiments, in which wafer 100 may be placed within wall cavity 120 of a building, wafer 100 may have dimensions in the range of about three inches wide and about fourteen inches long.

Wafer 100 comprises wood substrate 210 and corrugated substrate 220 assembled in alternating layers. The layers may be formed using the same materials for wood substrate 210 and corrugated substrate 220, or the layers may be formed using different materials for wood substrate 210 and corrugated substrate 220. Both wood substrate 210 and corrugated substrate 220 may be formed from a cellulosic material.

Wood substrate 210 may be formed from any wood or combination of woods, for example, pine or cork or both. Wood substrate 210 may have a thickness in the range of from about ⅛ inches to about ¾ inches.

Corrugated substrate 220 may be formed from a cellulosic material that may have one or more tunnels disposed through or within the cellulosic material. Examples of cellulosic materials suitable for corrugated substrate 220 include one or more of wood, cork, cardboard and paper. In certain embodiments, corrugated substrate 220 has a thickness in the range of from about ⅛ inches to about ¾ inches.

In general, wood substrate 210 and corrugated substrate 220 may be joined using any method so long as the layers are in substantial contact. In certain embodiments, the layers may be joined with a glue. One example of a suitable glue is Elmer's Wood Glue, commercially available from Elmer's Products, Inc., Columbus, Ohio. In other embodiments, the layers may be joined using a fastener, e.g., a nail, a screw, or metal strap. In one embodiment, wafer 100 comprises 3 layers of a pine wood for wood substrate 200 alternating with 2 layers of a cardboard for corrugated substrate 220, and the alternating layers are glued together.

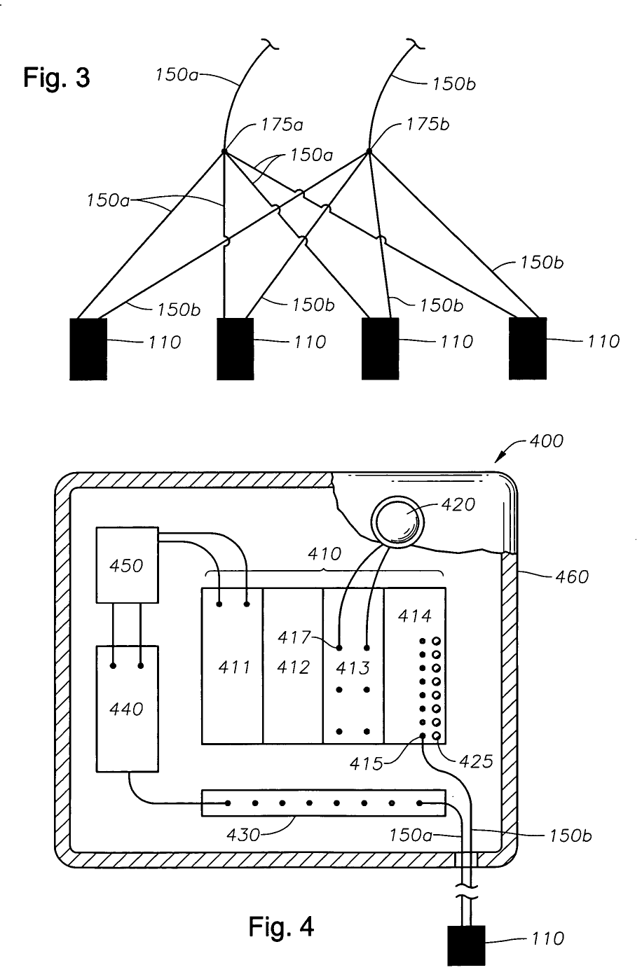

Referring now to FIG. 3, a schematic showing a plurality of sensors multiplexed to form a single circuit according to one embodiment of the present invention. In such configurations, more than one sensor 110 may be electrically connected in a parallel fashion. For example, each of lead 150a and 150b from sensor 110 may be electrically connected to connection 175a and connection 175b respectively. A single circuit can then be formed using a plurality of sensors by connecting leads 150a and 150b to terminal block 430 (shown in FIG. 4) and digital processor 410 (shown in FIG. 4). Any number of sensors may be connected in parallel fashion. For example, in certain embodiments, from about four to about eight sensors are connected in parallel. When sensors are multiplexed, if any one sensor is triggered, the whole circuit activates. When placed in a building, multiplexed sensors may be used to form alarm zones. By using more than one sensor per circuit, the overall costs of the system may be reduced.

Referring now to FIG. 4, a cross-sectional view illustrates enclosure 400. Enclosure 400 comprises digital processor 410, warning device 420, terminal block 430, field power supply 440, AC power supply 450, and enclosure housing 460. In some embodiments, digital processor 410 may be any digital processor, such as a programmable logic controller (PLC) a microcontroller, a microprocessor, an application specific integrated circuit, a programmable logic array, and a digital signal processor. Digital processor 410 as shown in FIG. 4 is a PLC that comprises a power supply module 411, a central processing unit (CPU) module 412, an output module 413, and an input module 414. In general, digital processor 410 may be built and programmed by a systems integration center so as to turn on warning device 420 when sensor 110 is triggered by moisture. In one embodiment, digital processor 410 is Automation Direct DL240 digital processor with spring-clamp I/O, 12/24 volt DC discreet inputs, 24 volt DC discreet outputs, and an external 12 volt DC power supply for field circuits, commercially available from Automation Direct of Cumming, Ga. Enclosure 460 may be any commercially available instrument enclosure housing. As discussed above warning device 420 may be any type of warning device, or combination of warning devices.

Modules 411-414 of digital processor 410 are inserted into the backplane (not shown in FIG. 4) of digital processor 410, which electrically connects the modules. Power supply module 411 converts alternating current from power supply 450 to direct current, which is distributed to modules 412-414 through the backplane.

CPU module 412 may be programmed with operating commands suitable for the systems of the present invention. In one embodiment, the programming may use a single rung of ladder logic in which all the inputs and outputs are normally-open contacts, and the inputs and outputs are connected. Thus, if sensor 110 detects enough moisture to activate input 415, the program would energize output 417 and turn on warning device 420. In some embodiments, CPU module 412 also may be programmed to turn on warning device 420 in case the digital processor diagnostics detect a component failure.

Output module 413 is a 24-volt output card that may be electrically connected to warning device 420; or, in certain embodiments, to more than one warning device 420 (not shown in FIG. 4). Input module 414 is a 12/24-volt input card that may be capable of accepting more than one input. Input module 414 also may include one or more light emitting diodes (LED), e.g., LED 425. Each input (e.g., input 415 ) on input module 414 should correspond to a LED (e.g., LED 425 ) so that when the input receives a signal, the corresponding LED is activated. In certain embodiments, module 414 may accept inputs in the range of from about 1 to about 32. For example, module 414 may accept inputs from 16 individual sensors.

Lead 150a and 150b from sensor 110 may be disposed through enclosure 460. Lead 150a should be connected to terminal block 430; and lead 150b should be connected to input module 414. Each sensor should have a physical address on the input module 414 that corresponds to a LED. For example, sensor 110 is connected to input module 414 at input 415 so that when sensor 110 is triggered, LED 425 is turned on. This way a triggered sensor's location in a building can be determined after comparison to a sensor map (described above).

AC power supply 450 supplies power to digital processor 410 and sensor 110. AC power supply 450 is electrically connected to digital processor 410 and to field power supply 440. Field power supply 440 converts alternating current from power supply 450 and provides 12-volt direct current to terminal block 430, which should be internally jumpered. As discussed above, one or more sensors may be electrically connected to terminal block 430 and to input module 414, thus completing an electrical circuit. AC power supply 450 is electrically connected to building's electrical supply, e.g., 110-volt alternating current. AC power supply 450 should be grounded for safety, e.g., by using the building's ground.

The systems of the present invention may be used in methods of detecting termites in a building. Such methods comprise installing a moisture detection system in a building, wherein the moisture detection system comprises a sensor that generates a signal when there is moisture, a digital processor coupled to the sensor, a warning device coupled to the digital processor; and monitoring the moisture detection system until moisture is detected in the building. In one embodiment of the methods of the present invention, moisture may trigger sensor 110 (shown in FIG. 1 and FIG. 4). In turn, digital processor 410 (shown in FIG. 4) turns on LED 425 (shown in FIG. 4) and warning device 420 (shown in FIG. 1 and FIG. 4). The alarm from warning device 420 may be noticed by an operator, who can check LED 425 on input module 414 to determine the sensor triggered.

In one application, the systems of the present invention may be used to detect the presence of moisture resulting from a leak, e.g., a plumbing leak. And in certain embodiments, in which the leak is small, the use of wafer 100 may allow earlier moisture detection. By way of explanation, and not of limitation, it is believed that the corrugations of corrugated substrate 220 of wafer 100 can trap moisture to facilitate early detection of moisture by sensor 110.

In another application, the systems of the present invention may be used to detect the presence of moisture that has been introduced into a building by termites. In order to consume wood in a building, termites require moisture. Accordingly, termites may transport moisture (e.g., in the form of mud) into wood they are consuming, especially if the wood is dry. In the case of wafer 100, when termites start to consume wood substrate 200 or corrugated substrate 220 or both, moisture may be transferred to sensor 110. By way of explanation, and not of limitation, it is believed that wood substrate 200 may provide a suitable food source for a termite, while the tunnels of corrugated substrate 220, which resemble natural termite tunnels, allow easier access to wood substrate 200.

To facilitate a better understanding of the present invention, the following examples are given. In no way should these examples be read to limit or to define the scope of the invention.

### EXAMPLES

The Delmhorst GB-1 Gypsum Block sensors are designed to operate on low AC voltage. To test whether the sensors could detect moisture using a DC current 3 test probes were pretreated by soaking and drying in water as directed by the Delmhorst GB-1 Gypsum Block sensor instructions. Next a 13-volt DC excitation voltage was sent to the probes through 100 feet of 24 gage Carol Cable Co. speaker wire (−0.1 volts/50 feet voltage drop) using an AC-to-DC plug-in power adapter. The voltage from the sensors was measured with a Fluke voltmeter. The results are shown in Table 1.

TABLE 1

| Sensor | | | Wet Sensor Voltage |
|---|---|---|---|
| Number | Supply Voltage | Dry Sensor Voltage | (one drop of water) |
| 1 | 12.9 | 5.1 | 11.8 |
| 2 | 12.9 | 4.3 | 8.4 |
| 3 | 12.9 | 3.4 | 9.4 |

The above test demonstrated, among other things, that the Delmhorst GB-1 Gypsum Block sensors could be used with a DC voltage and still detect moisture.

A system that uses 24-volt DC power was thought to be ideal because most digital processors have a built-in 24-volt excitation supply. Testing revealed, however, that a 24-volt excitation voltage resulted in voltage swings that were too great (data not shown). Thus, a 12-volt power supply external to the digital processor was needed for the model system using a digital processor and Delmhorst GB-1 Gypsum Block sensor.

Based on the above results a model system using 12-volt direct current and GB-1 Gypsum Block sensors was assembled using the following components: an Automation Direct DL240 with spring-clamp I/O with a 12/24-volt DC input card and a 24-volt DC output card; an Automation Direct amber alarm light; an Automation Direct 12-volt DC power supply; and two GB-1 Gypsum Block sensors (Sensor A and Sensor B). Carol Cable 24-gage paired wire was used to electrically connect the components.

The model system was tested in an environment designed to simulate actual working conditions as follows. A hole was cut into the drywall of a house wall and two GB-1 Gypsum Block sensors, sensor A and sensor B, were placed in the wall cavity. The hole was sealed by replacing the cut out drywall piece, and the sensors tested over several days in various outdoor weather conditions. The conditions included morning (high humidity), afternoon (low humidity) and spraying the outside wall with a garden hose and spray nozzle (simulated rainstorm or pressure washing).

The 12-volt DC input card that was used in the model system required at or above about a 10-volt excitation to detect a signal from the GB-1 Gypsum Block sensor. So, when power is applied to a dry GB-1 Gypsum Block sensor there must be less than about a 10-volt excitation to avoid a false alarm. A 12-volt DC excitation voltage was applied to Sensor A and Sensor B and the voltage was measured with a Fluke voltmeter. The voltages measured remained below the about 10-volt threshold. Specifically, Sensor A measured 5.6 volts and Sensor B measured 5.7 volts at a relative humidity of 100%. Accordingly, the 12/24-volt DC input card and GB-1 Gypsum Block sensor should not result in a false alarm.

To test the ability of Sensor A and Sensor B to reach the 10-volt threshold when exposed to moisture, 12-volt DC current was applied to the probes and the voltage was measured before and after moisture was introduced. Sensor A and Sensor B also were measured 4 hours and 8 hours after 8 drops of water were added to the probes. Table 2 lists the results of the voltage measurements.

TABLE 2

| | | | | | Avg. |
|---|---|---|---|---|---|
| Moisture | | Initial | Final | Percent | percent |
| (drops of water) | Probe | volts | volts | increase | increase |
| 2 | A | 2.5 | 4.7 | 85 | 87 |
| 2 | B | 3.1 | 5.8 | 88 | |
| 4 | A | 2.5 | 5.2 | 107 | 132 |
| 4 | B | 3.1 | 7.9 | 158 | |
| 6 | A | 2.5 | 8.0 | 219 | 215 |
| 6 | B | 3.1 | 9.6 | 212 | |
| 8 | A | 2.5 | 11.0 | 337 | 296 |
| 8 | B | 3.1 | 10.9 | 255 | |
| 8 (4 hours later) | A | | 11.7 | 364 | 320 |
| 8 (4 hours later) | B | | 11.6 | 275 | |
| 8 (8 hours later) | A | | 3.7 | 48 | 53 |
| 8 (8 hours later) | B | | 4.9 | 58 | |

The above examples demonstrate, among other things, that the systems and methods of the present invention are capable of detecting moisture.

Therefore, the present invention is well adapted to attain the ends and advantages mentioned as well as those that are inherent therein. While numerous changes may be made by those skilled in the art, such changes are encompassed within the spirit of this invention as defined by the appended claims.

What is claimed is:

2. A termite detection system, the system comprising:
at least one sensor, wherein the sensor generates a signal when there is moisture caused by termite activity;
at least one digital processor coupled to the sensor, wherein the digital processor receives the signal from the sensor; and
at least one warning device coupled to the digital processor, wherein the warning device is activated when the digital processor receives the signal from the sensor.

3. The system of claim 2 further comprising a wafer, wherein the wafer comprises a wood substrate and a corrugated substrate.

4. The system of claim 2 further comprising a building, the building having at least one wall formed at least in part from a cellulosic material.

5. The system of claim 2 further comprising a building, the building having at least one wall formed from a cellulosic material, and a plurality of sensors advantageously located with the walls for optimal determination of moisture caused by termite activity.

6. The system of claim 2 further comprising a building and a sensor map, wherein the sensor map identifies the location of the sensor in a building.

7. The system of claim 2 wherein the sensor comprises a plurality of sensors that are multiplexed together.

8. The system of claim 2 wherein at least one digital processor is chosen from a programmable logic controller, a microcontroller, a microprocessor, an application specific integrated circuit, a programmable logic array, and a digital signal processor.

9. The system of claim 2 wherein the digital processor comprises at least a power module, a central processing unit (CPU) module, an output module, and an input module.

10. The system of claim 2 wherein the warning device comprises a visual signal.

11. The system of claim 2 wherein the warning device comprises an audible signal.

12. A method for detecting termites in a building, the method comprising:
installing a termite detection system in the building, wherein the termite detection system comprises:
at least one sensor, wherein the sensor generates a signal when there is moisture caused by termite activity;
at least one digital processor coupled to the sensor, wherein the digital processor receives the signal from the sensor;
at least one warning device coupled to the digital processor, wherein the warning device is activated when the digital processor receives the signal from the sensor; and
monitoring the termite detection system until moisture is detected in the building.

13. The method of claim 12 wherein the termite detection system further comprises a wafer, wherein the wafer comprises a wood substrate and a corrugated substrate.

14. The method of claim 12 wherein the termite detection system further comprises a sensor map, wherein the sensor map identifies the location of the sensor in the building.

15. The method of claim 12 wherein the sensor comprises a plurality of sensors that are multiplexed together.

16. The method of claim 12 wherein the building is a building having at least one wall formed at least in part from a cellulosic material.

17. The method of claim 12 wherein the building is a building having at least one wall formed at least in part from a cellulosic material and a plurality of sensors advantageously located with the walls for optimal determination of moisture caused by termite activity

18. The method of claim 12 wherein at least one digital processor is chosen from a programmable logic controller, a microcontroller, a microprocessor, an application specific integrated circuit, a programmable logic array, and a digital signal processor

19. The method of claim 12 wherein the digital processor comprises at least a power module, a central processing unit (CPU) module, an output module, and an input module.

20. The method of claim 12 wherein the warning device comprises a visual signal.

21. The method of claim 12 wherein the warning device comprises an audible signal.
